(19) United States
(12) Patent Application Publication
(10) Pub. No.: US 2023/0368043 A1
(43) Pub. Date: Nov. 16, 2023

(54) SYSTEMS AND METHODS FOR MACHINE LEARNING MODELS FOR INTERACTION INSIGHTS

(71) Applicant: Included Health, Inc., San Francisco, CA (US)

(72) Inventors: Derek Macklin, San Francisco, CA (US); Richard Wolf, San Francisco, CA (US); Eric Carlson, San Francisco, CA (US); Daniel Austin, San Francisco, CA (US)

(73) Assignee: Included Health, Inc., San Francisco, CA (US)

(21) Appl. No.: 17/745,819

(22) Filed: May 16, 2022

(51) Int. Cl. G06N 5/02

(52) U.S. Cl. CPC G06N 5/022

(57) ABSTRACT

Methods, systems, and computer-readable media for the generation of customizable insights using machine learning models. The method acquires data from one or more sources with different formats and data organization to extract events that each represent an interaction between a user and a service and classify the extracted events by adding labels to each of the extracted events. The method next projects the extracted events and generates the customized insights of events representing user interactions.

### BACKGROUND

An ever increasing amount of data and data sources are now available to researchers, analysts, organizational entities, and others. This influx of information allows for sophisticated analysis but, at the same time, presents many new challenges for sifting through the available data and data sources to locate the most relevant and useful information. As the use of technology continues to increase, so, too, will the availability of new data sources and information.

Because of the abundant availability of data from a vast number of data sources, determining the optimal values and sources for use presents a complicated problem difficult to overcome. Accurately utilizing the available data can require both a team of individuals possessing extensive domain expertise as well as many months of work to evaluate the outcomes. The process can involve exhaustively searching existing literature, publications, and other available data to identify and study relevant data sources that are available both privately and publicly.

While this approach can often provide effective academic analysis, applying these types of analytical techniques to domains requiring accurate results obtainable only through time and resource intensive research is incompatible with modern applications' demands. For example, the developed process for evaluating outcomes may not line up with specific circumstances or individual considerations. In this scenario, applying the process requires extrapolation to fit the specific circumstances, to dilute the process's effectiveness, or to require spending valuable time and resources to modify the process. As a result, processes developed in this way typically provide only generalized guidance insufficient for repurposing in other settings or by other users. As more detailed and individualized data becomes available, demand for the ability to accurately discern relevant data points from the sea of available information, and efficiently apply that data across thousands of personalized scenarios increases.

### SUMMARY

Certain embodiments of the present disclosure relate to a non-transitory computer readable medium including instructions that are executable by one or more processors to cause a system to perform a method for customized insights. The method may include acquiring data from one or more sources, wherein the one or more sources format and organize the data differently, extracting, from the acquired data, events that each represent an interaction between a user and a service, classifying the extracted events by adding one or more labels to each of the extracted events, projecting the extracted events to the acquired data, and generating the customized insights of the extracted events representing user interactions.

According to some disclosed embodiments, extracting events may further include receiving, for the acquired data, one or more annotations that are defined using a configuration file and that indicate an event of the events in the data, and determining one or more tags to associate with the acquired data using machine learning models based on the one or more annotations, wherein the one or more tags indicate one or more intentions of the user and one or more actions of the service provider, wherein the one or more tags indicate the extracted events in the data.

According to some disclosed embodiments, the one or more tags indicate the extracted events using one or more mappings between the one or more intentions and the one or more actions.

According to some disclosed embodiments, one or more mappings between the one or more intentions and the one or more actions is determined using a multi-label or multi-class classification model.

According to some disclosed embodiments, a machine learning model of the machine learning models is trained using the one or more mappings between the one or more intentions and the one or more actions.

According to some disclosed embodiments, the method may further include receiving a communication from a user, determining intent of the communication using the trained machine learning model, determining one or more recommendation actions based on the determined intent of the communication, wherein the one or more recommendations are generated by a multi-label classifier, generating one or more responses associated with the one or more recommendation actions, and presenting the one or more response communications in a consumable format.

According to some disclosed embodiments, the received communication is at least one of: an email, a chat message, or a phone call.

According to some disclosed embodiments, determining one or more tags to associate with the data using machine learning models includes generating a hierarchy of the one or more tags.

According to some disclosed embodiments, projecting the extracted data may further include generating one or more slices of the data, and projecting the one or more slices and the one or more tags of data to the document content.

According to some disclosed embodiments, projecting the one or more slices and the one or more tags of data to the document content may further include generating a table to include the one or more slices as one or more records, including the data as field of the one or more records, and including additional information as fields of the one or more records.

According to some disclosed embodiments, classifying the acquired data by adding one or more labels to each of the acquired data may further include grouping the one or more labels to a core topic, wherein the core topic indicates the communication intent of the user.

According to some disclosed embodiments, generating customized insights of the extracted events representing user interactions is based on the machine learning models selected from a machine learning models repository using a configuration file.

Certain embodiments of the present disclosure relate to a method performed by a system for generating customized insights. The method may include acquiring data from one or more sources, wherein the one or more sources format and organize the data differently, extracting, from the acquired data, events that each represent an interaction between a user and a service, classifying the extracted events by adding one or more labels to each of the extracted events, projecting the extracted events to the acquired data, and generating the customized insights of the extracted events representing user interactions.

According to some disclosed embodiments, extracting events may further include receiving, for the acquired data, one or more annotations that are defined using a configuration file and that indicate an events of the events in the data, and determining one or more tags to associate with the acquired data using machine learning models based on the one or more annotations, wherein the one or more tags indicate one or more intentions of a user and one or more actions of a service provider, wherein the one or more tags indicate the extracted events in the data.

According to some disclosed embodiments, the one or more tags indicate the extracted events using one or more mappings between the one or more intentions and the one or more actions.

According to some disclosed embodiments, a machine learning model of the machine learning models is trained using the one or more mappings between the one or more intentions and the one or more actions.

According to some disclosed embodiments, the method may further include receiving a communication from the user, determining intent of the communication using the trained machine learning model, determining one or more recommendation actions based on the determined intent of the communication, wherein the one or more recommendations are generated by a multi-label classifier, generating one or more responses associated with the one or more recommendation actions, and presenting the one or more response communications in a consumable format.

According to some disclosed embodiments, projecting the extracted data may further include generating one or more slices of the data, and projecting the one or more slices and the one or more tags of data to the document content.

According to some disclosed embodiments, projecting the one or more slices and the one or more tags of data to the document content may further include generating a table to include the one or more slices as one or more records, including the data as field of the one or more records, and including additional information as fields of the one or more records.

Certain embodiments of the present disclosure relate to a system for generating interaction insights. The system includes one or more processors executing processor-executable instructions stored in one or more memory devices to perform a method. The method may include acquiring data from one or more sources, wherein the one or more sources format and organize the data differently, extracting, from the acquired data, events that each represent an interaction between a user and a service, classifying the extracted events by adding one or more labels to each of the extracted events, projecting the extracted events to the acquired data, and generating the customized insights of the extracted events representing user interactions.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram showing various exemplary components of an interaction insights system, according to some embodiments of the present disclosure.

FIG. 2 is a block diagram showing various exemplary components of tagger module of interaction insights system of FIG. 1, according to some embodiments of the present disclosure.

FIG. 3 is a flow diagram of an exemplary annotation pipeline performed by annotator module of interaction insights system of FIG. 1, according to some embodiments of the present disclosure.

FIG. 4 is a flow diagram of an exemplary tagging pipeline of FIG. 2, according to some embodiments of the present disclosure.

FIG. 5 is a flow diagram of an exemplary representation of a data projection table, according to some embodiments of the present disclosure.

FIG. 6 is a diagram showing intent and action taxonomy determined using interaction insights system of FIG. 1, according to some embodiments of the present disclosure.

FIG. 7 illustrates a schematic diagram of an exemplary server of a distributed system, according to some embodiments of the present disclosure.

FIG. 8 is a flowchart showing an exemplary method for generating insights using labeled interaction content, according to some embodiments of the present disclosure.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed simultaneously, at the same point in time, or concurrently. Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

The embodiments described herein provide technologies and techniques for evaluating large numbers of data sources and vast amounts of data used in the creation of a machine learning model. These technologies can use information relevant to the specific domain and application of a machine learning model to prioritize potential data sources. Further, the technologies and techniques herein can interpret the available data sources and data to extract probabilities and outcomes associated with the machine learning model's specific domain and application. The described technologies can synthesize the data into a coherent machine learning model, that can be used to analyze and compare various paths or courses of action.

These technologies can efficiently evaluate data sources and data, prioritize their importance based on domain and circumstance specific needs, and provide effective and accurate predictions that can be used to evaluate potential courses of action. The technologies and methods allow for the application of data models to personalized circumstances. These methods and technologies allow for detailed evaluation that can improve decision making on a case-by-case basis. Further, these technologies can evaluate a system where the process for evaluating outcomes of data may be set up easily and repurposed by other uses of the technologies.

Technologies may utilize machine learning models to automate the process and predict responses without human intervention. The performance of such machine learning models is usually improved by providing more training data. A machine learning model's prediction quality is evaluated manually to determine if the machine learning model needs further training. Embodiments of these technologies described can help improve machine learning model predictions using the quality metrics of predictions requested by a user.

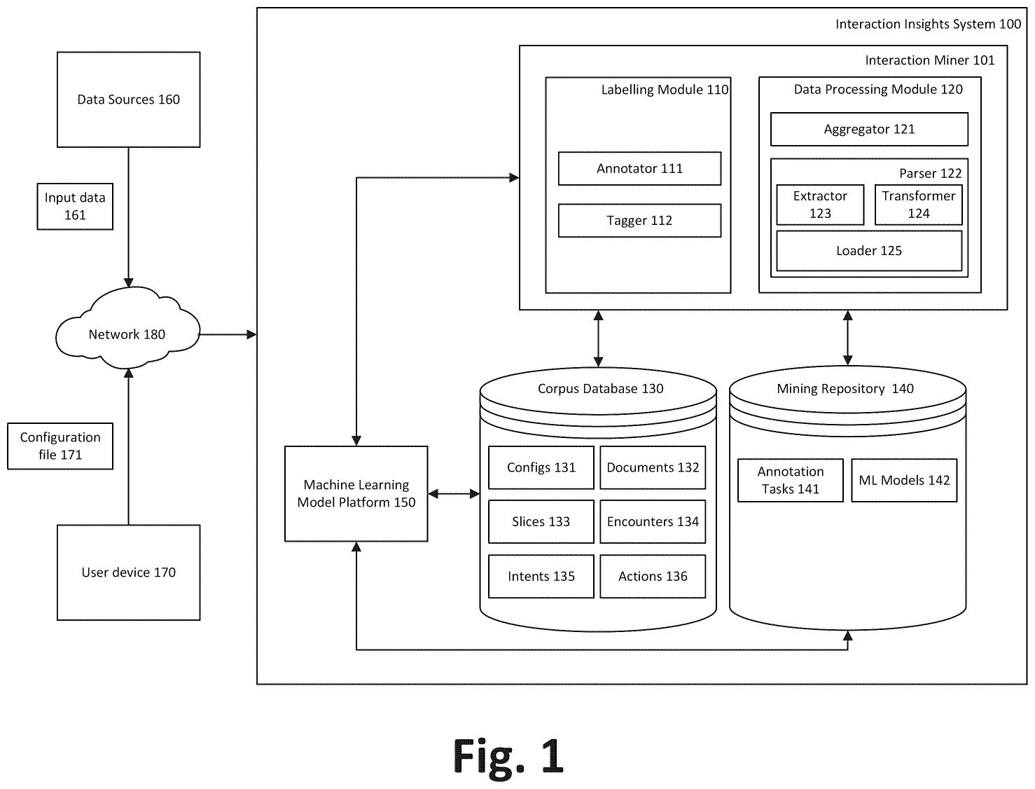

FIG. 1 is a block diagram showing various exemplary components of an interaction insights system, according to some embodiments of the present disclosure.

As illustrated in FIG. 1, interaction insights system 100 may include interaction miner 101 to determine labels to associate with input data 161 and use the labels to determine insights. Interaction insights system 100 may use additional configuration details. Interaction miner 101 may include labeling module 110 and data processing module 120 to determine labels and insights. Interaction miner 101 may use corpus database 130 to store and access various labels and insights of input data 161. Interaction miner 101 may use mining repository 140 to get the definitions of tasks and models to generate labels and insights. Interaction miner 101 works with machine learning model platform 150, corpus database 130, and mining repository 140 to generate labels and insights semi-supervised and unsupervised.

Interaction insights system 100 may also include Machine Learning (ML) platform 150 to help determine labels to associate with input data 161 and determine insights based on associated labels. Interaction miner 101 and ML model platform 150 may access data and configurations in corpus database 130 and mining repository 140 to generate labels to determine insights

Labeling module 110 may aid in labeling input data 161 retrieved from data sources 160. Labeling module 110 may store parts of the retrieved input data 161 along with generated labels in corpus database 130. Labeling module 110 may include manual processing of input data 161 using annotator 111 and automatic and real-time processing of input data 161 using tagger 112 to generate labels. In some embodiments, labeling module 110 may be configured to generate different labels and types of labels for matching data. Configurations may include configurations for annotator 111 and tagger 112 and stored in corpus database 130. A user of interaction insights system 100 may provide configurations through user device 170 using configuration file 171.

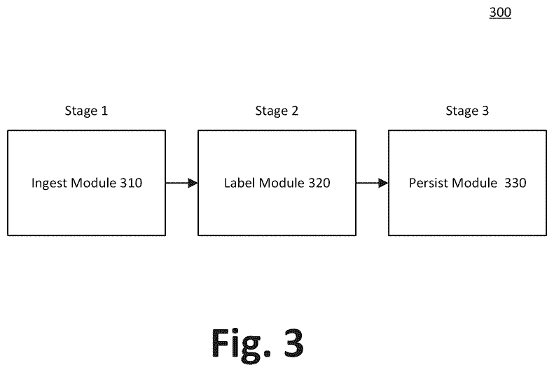

Annotator 111 may help annotate input data 161 by providing a list of annotations to use with the content in documents 132 of input data 161. Annotator 111 may be configured to include the list of annotations and a list of documents to process with a list of annotators. Annotator 111 may receive the configuration (e.g., configuration file 171) over network 180. Configuration file 171 may be a text file or a structured document such as a YAML or JSON. In some embodiments, configuration file 171 may include a list of documents or a database query to select the list of documents. In some embodiments, a list of documents may be presented as a regex formula to match a set of documents. Configuration file 171 may include additional details for annotations and stored as annotation tasks 141 in mining repository 140. A detailed description of determining annotation tasks 141 and annotating documents 132 using labels is provided in FIG. 3 description below.

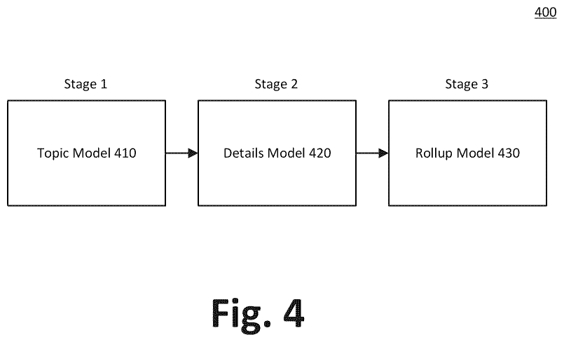

Tagger 112 may automatically tag documents 132 with labels using machine learning (ML) model platform 150. Interaction insights system 100 may train tagger 112 using documents annotated with labels provided by annotator 111. In some embodiments, tagger 112 may be used with unstructured documents and need auto labeling of the documents. A detailed description of using tagger 112 to generate tags to associate labels with documents 132 is provided in FIG. 4 description below.

Data processing module 120 takes as input original documents 132 and the labels provided by annotator 111 and tagger 112 to generate insights about the contents of documents 132. Data processing module 120 may store the insights in corpus database 130. Data processing module 120 may include aggregator 121 to help combine various interaction parts in documents 132 to generate insights. Interaction insights system 100 may generate various insights, including encounters 134 indicating various interaction encounters stored as documents 132, intents 135 indicating the intention of interaction content in documents 132, actions 136 indicating various actions taken during interactions stored as documents 132.

Aggregator 121 may aggregate interaction in documents 132 by rolling up multiple labels associated with documents 132 using annotator 111 and tagger 112. Aggregator 121 may include an ML model to roll up labels to higher levels labels in a hierarchy of labels to determine various insights (e.g., encounters 134, intents 135, and actions 136) to associate with interactions in documents 132. Aggregator 121 may store the determined insights by rolling up labels in corpus database 130.

Parser 122 may retrieve data from various data sources 160 and process the data to documents 132 so that it may be used with the remainder of interaction insights system 100. Parser 122 may further include extractor 123, transformer 124, and loader 125 modules. Extractor 123 and transformer 124 may work together to generate documents 132 and other data in corpus database 130. Transformer 124 may connect the disparate data extracted from data sources 160 by extractor 123 and store it in corpus database 130.

Extractor 123 retrieves input data 160 from data sources 160, and each of these data sources may represent a different type of data source. A data source may represent structured data such as hierarchical topics selected by a service provider communicating with a user or a usage log of a service by a user. In some embodiments, data sources may be flat files, such as call and chat transcripts. Further, data sources may contain overlapping or completely disparate data sets. In some embodiments, a data source may contain information about a user usage log of a service. In contrast, other data sources may contain various disparate topics a user discussed with a service provider. Extractor 123 may interact with the various data sources, retrieve the relevant data, and provide that data to transformer 124.

Transformer 124 may receive data from extractor 123 and process the data into standard formats. In some embodiments, transformer 124 may normalize data such as dates. For example, a data source for a service usage log may store dates in a day-month-year format, while a data source for chat transcripts may store dates in a year-month-day format. In this example, transformer 124 may modify the data provided through extractor 123 into a consistent date format. Accordingly, transformer 124 may effectively clean the data provided through extractor 123 so that all of the data, although originating from a variety of sources, has a consistent format. For example, usage data may include a user ID of a user, but a chat transcript may include the full name of the same user. In the second example, transformer 124 may include the missing full name in a usage log of a service.

Moreover, transformer 124 may extract additional data points from the data sent by extractor 123. For example, transformer 124 may process a date in a year-month-day format by extracting separate data fields for the year, the month, and the day. Transformer 124 may also perform other linear and non-linear transformations and extractions on categorical and numerical data, such as normalization and demeaning. Transformer 124 may provide the transformed and/or extracted data to loader 125. In some embodiments, transformer 124 may store the transformed data in corpus database 130 for later use by loader 125 and other components of interaction miner 101.

Loader 125 may receive the normalized data from transformer 124. Loader 125 may merge the data into varying formats depending on the specific requirements of interaction insights system 100 and store the data in an appropriate storage mechanism such as corpus database 130. Loader 125 may store input data 161 processed by various components of parser 122 as documents 132.

Corpus database 130 may include raw input data 161 stored as documents 132 and configurations to label documents as configs 131. Corpus database 130 may also store various portions of content as slices 133. Interaction miner 101 may use slices 133 to determine various insights of interaction content present in documents 132. Corpus database 130 may also include various insights of content in documents 132 as encounters 134, intents 135, and actions 136.

Configs 131 may include configuration parameters to determine labels to associate with documents 132 and generate insights of interaction content in documents 132. Configs 131 may include configuration file 171 sent over network 180. Configs 131 may include flat files in an unstructured format as text files or semi-structured XML or JSON files. In some embodiments, configs 131 may include parsed content from configuration file 171. Configs 131 may store parsed content as database tables.

Documents 132 may include various interaction content of a user with various service providers and services. Documents 132 may include transcripts of interactions between users and service providers over chat or phone. In some embodiments, transcripts may include interaction with services via chatbots. Documents 132 may also include the interaction behavior of a user with a service. Documents 132 may also include service providers' interactions with services when interacting with a user. In some embodiments, service providers' interaction with services may include selecting summary topics of an interaction with a user.

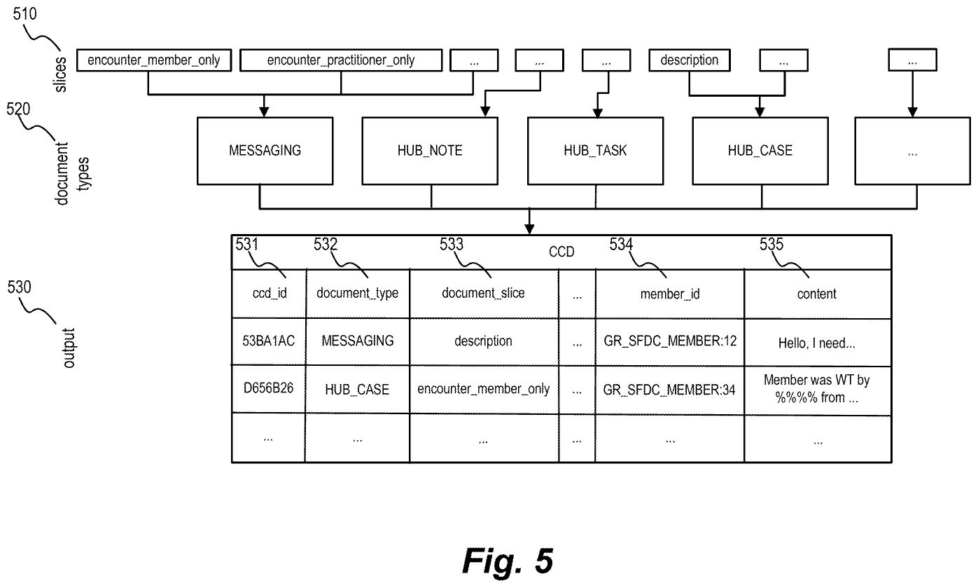

Slices 133 may include a portion of the content in documents 132. For example, a slice of interaction between users and service providers may include only the user or service provider portion of an interaction. Slices 133 may help better identify insights of interactions between users, services providers, and services by determining if a certain action or end result of interaction can be attributed to a user or a service provider. For example, a user may reach out to a service provider for information about a service but may leave the conversation mid-way as they have identified the required answer themselves. In such cases, interaction insights should not attribute an act of providing an answer to a user's question to service providers. Interaction insights system 100 may use slices 133 to associate appropriate labels and determine insights based on the labels. A detailed description of a slice format is provided in FIG. 5 description below.

Encounters 134 may include interactions by a user with various services and systems operated by an entity. Encounters 134 may define the boundaries in interactions stored in documents 132. Multiple encounters 134 may be part of a single interaction insight. For example, a user may first attempt to find information by using a service and may later chat or call a service provider to find the same information. In some embodiments, a single interaction may have multiple encounters. For example, a user may begin an encounter by interacting with a service provider on a first topic, and when the service provider gives a solution may begin a new encounter by interacting about a second topic. For example, a member of a healthcare network may ask a healthcare network provider about maternity benefits and upon identifying various maternity benefits offered by the member's employer may request for scheduling an appointment with a healthcare professional to avail one of the identified maternity benefits.

Intents 135 may be specialized labels to indicate a user's needs interacting with a service or a service provider. Tagger 112 may use an ML model of ML models 142 to determine tags to use as intent labels. Intents 135 may include links with encounters 134 and documents 132. Tagger 112 may use a specialized model, for example, a multi-label model, to tag labels identifying the intent of user interaction with a service provider.

Actions 136 may be specialized labels associated with documents 132 to indicate the solutions provided by service providers interacting with users. Actions 136 may include links with encounters 134 and documents 132. Tagger 112 may use a different ML model of ML models 142 to associate actions of actions 136 with encounters 134 present in documents 132. For example, Tagger 112 may use a multi-class model to identify various possible actions. A detailed description of a pipeline of tagging using various ML models is presented in FIG. 4 description below.

Mining repository 140 may include various configurations and definitions for extracting relevant parts from input data 161 to store in corpus database 130. Mining repository 140 may include annotation tasks 141 and ML models 142 to define and assign labels to content in documents 132.

Annotation tasks 141 include definitions of annotations to add as labels to documents 132. A user of interaction insights system 100 may provide definitions of annotations as part of a configuration file (e.g., configuration file 171). A user may define the allowed labels to assign to various encounters 134 in documents 132.

ML Models 142 may include machine learning models trained by interaction miner 101 using ML model platform 150. ML models 142 may be trained using training data in corpus database 130. ML models 142 may be configured using configs 131 and set up for training using annotation tasks 141. Annotations identified using annotation tasks 141 may be used as training data for ML models 142.

In various embodiments, corpus database 130, mining repository 140, and data sources 160 may take several different forms. For example, mining repository 140 may be an SQL or NoSQL database, such as those developed by MICROSOFT™, REDIS, ORACLE™, CASSANDRA, MYSQL, various other types of databases, data returned by calling a web service, data returned by calling a computational function, sensor data, IoT devices, or various other data sources. Corpus database 130 may store data that is used during the operation of applications, such as interaction miner 101. For example, if interaction miner 101 is configured to generate labels to associate with documents 132, then interaction miner 101 may access definitions annotation tasks 141 to produce intents 135 and actions 136. Similarly, if interaction miner 101 is configured to provide insights, data processing module 120 may retrieve previously generated tags and annotations as input to generate a new set of labels identifying insights. In some embodiments, corpus database 130 and mining repository 140 may be fed data from an external source, or the external source (e.g., server, database, sensors, IoT devices, etc.) may be a replacement. In some embodiments, corpus database 130 may be data storage for a distributed data processing system (e.g., Hadoop Distributed File System, Google File System, ClusterFS, and/or OneFS). Depending on the specific embodiment of corpus database 130, interaction miner 101 may optimize the label data for storing and retrieving in corpus database 130 for optimal query performance.

Configuration file 171 may provide definitions of labels and insights by listing the regular expressions to match the text in input data 161 accessed by interaction insights system 100. Configuration file 171 may be presented as name-value pairs used to define the labels and insights requested by a user of user device 170. Interaction insights system 100 may parse configuration file 171 to generate and store annotation tasks 141 definitions. Configuration file 171 may include definitions of encounters 134 to use to capture a snapshot of input data (e.g., input data 161) from data sources 160. Interaction insights system 100 may receive configuration file 171 from user device 170 over network 180.

Interaction insights system 100 may include a defined structure for configuration file 171, such as YAML. Interaction insights system 100 may parse configuration file 171 in YAML format to generate labeling task definitions stored as configs 131 and annotation tasks 141. In some embodiments, configuration file 171 may be formatted using other programming languages notations such as JSON or using tools such as Protobuf to generate text-based files. In some embodiments, the generated configuration files are human-readable text using an ASCII character set.

Interaction insights system 100 may provide a graphical user interface to define encounters (e.g., encounters 134) and other details such as a hierarchy of intents 135 and actions 136 and generate a configuration file (e.g., configuration file 171). In some embodiments, interaction insights system 100 may provide various definitions of encounters 134 previously defined by a user in a dropdown UI. A user may generate a configuration file by selecting data elements of each type of encounter of encounters 134 using a GUI. In some embodiments, interaction insights system 100 may allow editing format of encounters 134, such as interaction responses that may uniquely identify encounters 134. Interaction insights system 100 may also include the ability to store the revised definitions of encounters 134 in corpus database 130. The use of structured languages such as YAML to format configuration files and repurposing entity definitions using a GUI may help standardize entity definitions and portability of requests for matching entities across various applications.

Network 180 may take various forms. For example, network 180 may include or utilize the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, or other types of network communications. In some embodiments, network 180 may include an on-premises (e.g., LAN) network, while in other embodiments, network 198 may include a virtualized (e.g., AWS™, Azure™, IBM Cloud™, etc.) network. Further, network 180 may, in some embodiments, be a hybrid on-premises and virtualized network, including components of both types of network architecture.

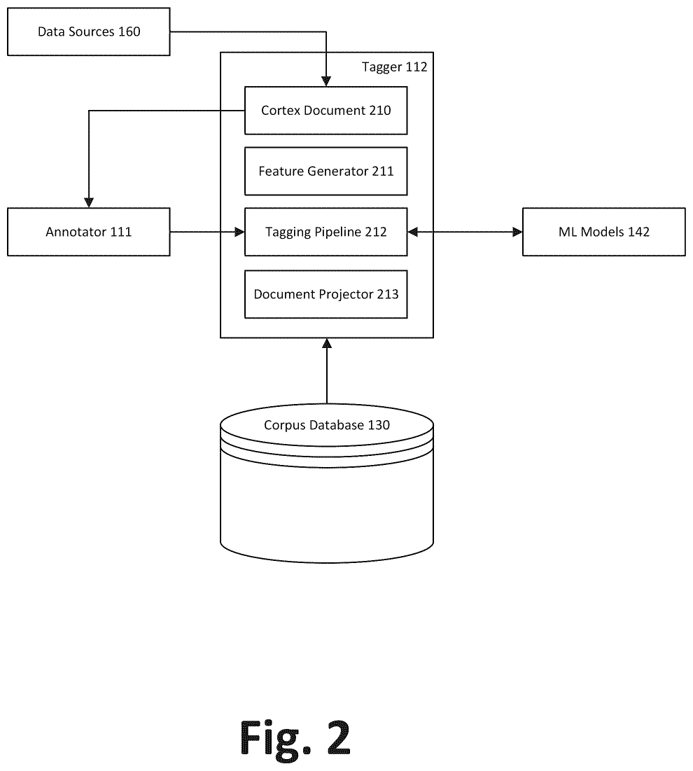

FIG. 2 is a block diagram showing various exemplary components of tagger 112 of interaction insights system 100 of FIG. 1, according to some embodiments of the present disclosure. Tagger 112 may process a document (e.g., cortex document 210) using other components of tagger 11. As illustrated in FIG. 2, tagger 112 components may include feature generator 211 to pre-process data (e.g., input data 161) to label data using tags, tagging pipeline 212 to generate the necessary tags using featured data generated by feature generator 211, and document projector 213 to persist relations between generated tags and documents (e.g., documents 132) of input data. In some embodiments, cortex document 210 is a container for multiple documents (e.g., documents 132) retrieved from input data 161.

Tagger 112 may receive cortex document 210 from data sources 160. In some embodiments, tagger 112 may access cortex document 210 from documents 132 in corpus database 130. Tagger 112 may provide the selected cortex document 210 to annotator 111 to receive an initial set of labels associated with the content of cortex document 210 and use them to generate additional labels using tagging pipeline 212.

Feature generator 211 may convert documents 132 of input data 161 to vector representations. In some embodiments, vector representation of documents 132 may be stored in place of documents 132. Feature generator 201 may use existing embedding techniques such as En Glove and Sci Glove embeddings. Tagger 112 may use multiple embeddings to determine various types of features of the content in a document (e.g., cortex document 210).

Feature generator 211 may generate features vectors in the form of embeddings. Feature generator 211 may choose different ML models to generate different embeddings based on the downstream processing by machine learning models (e.g., ML Models 142) used by tagging pipeline 212. For example, feature generator 201 may use a BioBERT model to generate word2vec embeddings and may use GloVe model to generate Sci GloVe and En GloVe embeddings. Feature generator 211 may generate embeddings of complete documents or parts of the document content (sentences and words). Feature generator 211 may use various tokenization techniques to generate tokens and use them to generate embeddings. For example, feature generator 211 may use parts of speech (POS), named entity recognizer (NER) techniques to tokenize content in cortex document 210. Feature generator 211 may use existing tools such as SpaCy to generate tokens using tokenization techniques listed above. Feature generator 211 may share feature vectors of documents generated from various embeddings of cortex document 21 with tagging pipeline to determine labels to generate insights about the content in cortex document 210.

Tagging pipeline 212 may include multiple machine learning models to understand cortex document 210 of input data 161 transformed into vector representation by feature generator 211. Tagging pipeline 212 may simultaneously employ multiple ML models of ML models 142 to determine various labels to tag different content details in cortex document 210. Tagging pipeline 212 may choose ML models based on the configuration provided by a user of interaction insights system 100 using configuration file 171. In some embodiments, tagging pipeline 212 may select ML models for determining labels based on the type of interaction content present in cortex document 210. For example, tagging pipeline 212 may choose different ML models for a document containing interaction between a user and a service and another document containing interaction between a user and a service provider. A detailed description of the tagging pipeline components and selection of ML models to associate various types of tags as labels is presented in FIG. 4 description below.

Tagger 112 may use a document projector 213 to retrieve specific portions of content in cortex document 210 to help determine insights from content in cortex document 210. The projected portions of a document can help ML models in ML models 142 to better associate labels with the content of a document (e.g., cortex document 210). An example of a document projection using document projector 213 is presented in FIG. 5 description below.

FIG. 3 is a flow diagram of an exemplary annotation pipeline performed by components of annotator 111 of interaction insights system 100 of FIG. 1, according to some embodiments of the present disclosure. Annotation pipeline 300 includes a sequence of stages to process input data 161 (as shown in FIG. 1) to generate an initial set of labels describing the content in input data 161. Annotation pipeline 300 may use a tool such as MLFlow Run to ingest, label, and persist labeled data based on a configuration file (e.g., configuration file 171 of FIG. 1). MLFlow Run may use a YAML based configuration file for executing annotation pipeline 300.

In stage 1, ingest module 310 uses configuration file 171 to determine the content (e.g., input data 161 of FIG. 1) to retrieve from data sources 160 (as shown in FIG. 1). Ingest module 310 may store retrieved input data 161 as documents 132. Ingest module 310 may process input data 161 to a uniform format and store it as documents 132. Ingest module 310 may access input data 161 from data sources 160 by API calls to RESTful endpoints of various data sources. In some embodiments, ingest module 310 determine which part of input data 161 to store as documents 132. Ingest module 310 may use a configuration with a database query and/or regular expressions to determine content in documents 132 to label. The configuration may be stored as an annotation task of annotation tasks 141 (as shown in FIG. 1)

In stage 2, label module 312 may allow the selection of labels automatically or present to a user to select a label to associate with the content of documents 132 (as shown in FIG. 1). Label module 312 may use off-the-shelf labeling tools to help label documents 132 be ingested in stage 1 by ingest module 310.

In stage 3, persist module 330 may persist the labels generated by label module 320 in stage 2 by storing them in corpus database 130. Persist module 330 may persist labeled data based on configuration (e.g., configuration file 171) provided by a user to interaction insights system 100.

FIG. 4 is a flow diagram showing an exemplary tagging pipeline 212 of FIG. 2, according to some embodiments of the present disclosure. Tagging pipeline 400 is used to tag various types of labels to the content in documents 132. Labels may identify various events present in content in documents 132 and additional details about the identified events. For example, in a healthcare context, documents 132 may contain communication between a member about options under their health plan for an ailment with a healthcare service provider. A tagging model may identify an event by identifying various things associated with an event present in the communication. For example, the intent of the member initiating the communication and the service provider's action to help resolve the member's request may be used to identify an event. In some embodiments, multiple tagging models in the form of a pipeline may be needed to identify events and tag labels related to the identified events.

Tagging pipeline 400 may generate tags relevant for identifying intentions and actions taken as part of a communication event between a member and a service provider. In some embodiments, tagging pipeline 400 may include additional models to identify additional details about the event, such as member satisfaction. As illustrated in FIG. 4, tagging pipeline 400 may include multiple machine learning models as tagging models to help tag various labels to identify events and event details. Tagging pipeline 400 may provide the output of one tagging model to another tagging model in stages. In some tagging pipeline 400 may include multiple machine learning models in each stage. Tagging pipeline 400 provides exemplary tagging models to utilize to identify events in the content in documents 132.

As illustrated in FIG. 4, tagging pipeline employs multiple machine learning models in ML models 142 to identify events and label the interaction. Tagging pipeline may use multiple ML models sequentially, with the output of one ML model shared as input to the next model in stages 1 to 3.

In stage 1, topic model 410 may identify the core topics of content in each document of documents 132. Topic model 410 may be a regular expression model using a set of regular expressions to determine the labels to use to tag documents 132. Topic model 410 may identify core topics that are foundational for the content in documents in each domain. For example, in a healthcare context, the core topics may include administrative and clinical topics. In the example context, a communication between a healthcare plan member and service provider could be tagged administrative for Q&A related to a membership plan and tagged clinical for Q&A related to recommendations for an ailment. Tagging pipeline 400 may be executed multiple times to provide multiple event topics found in the content of a document of documents 132.

In stage 2, details model 420 of ML models 142 is executed on ML model platform 150 to identify various details related to the event topic identified in stage 1 by topic model 410. Details model may include multi-label and multi-class models to identify intentions and actions. In the above example, communication between a member and healthcare service provider

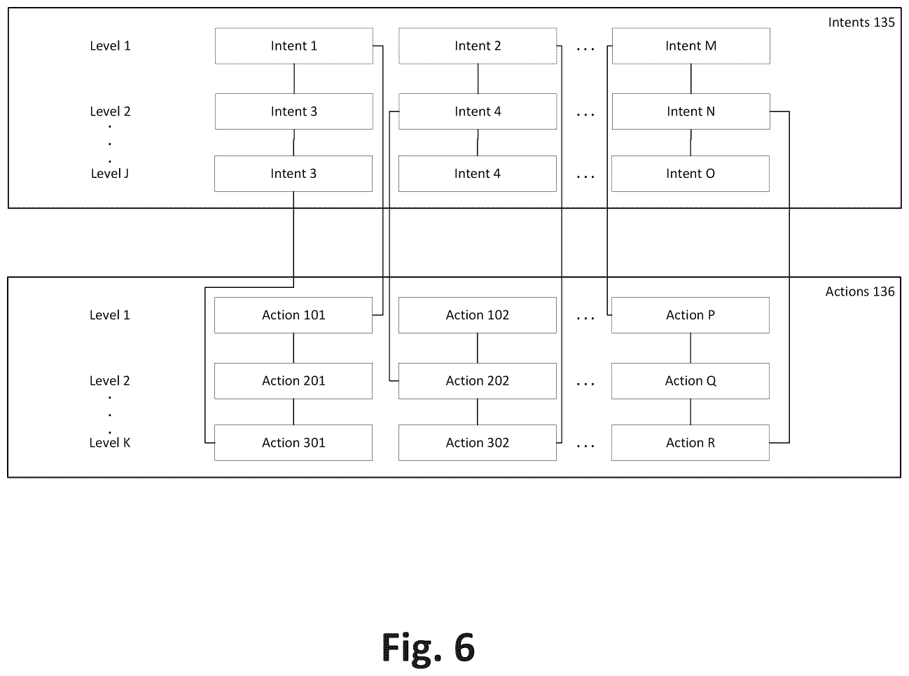

In stage 3, a rollup model 430 of ML models 142 may be used to group tagged labels. Labels determined using details model 420 may be rolled up based on a configuration (e.g., configuration file 171 of FIG. 1). a user of interaction insights system 100 may configure the level of details to use as tags prior to execution. Rollup model 430 may take hierarchical information of labels representing different levels as input along with labels identified by details model 420. An example hierarchical presentation of intents and actions is presented in FIG. 6 description below.

FIG. 5 is a flow diagram of an exemplary representation of a data projection table, according to some embodiments of the present disclosure. As illustrated in FIG. 5, interaction insights system 100 may project input data 161 (as shown in FIG. 1) into slices 510 stored as records in a table (e.g., Canonical corpus of documents (CCD) table 530). Interaction insights system 100 may determine slices based on input data 161 received from data sources 160 (as shown in FIG. 1). Data sources 160 may help define all possible slices. For example, an interaction between a user and a chatbot may result in slices to only include user only events with no service provider communication. In some embodiments, slices 510 may be defined based on configuration (e.g., configuration file 171 of FIG. 1) provided by a user of interaction insights system 100.

Interaction insights system 100 may select various data sources 160 to retrieve data for generating slices based on selected slices 510. Data sources 160 selected by interaction insights system 100 may define possible document types 520 from each of the sources.

In some embodiments, a user may define slices 510 along with document types 520 to use in order to populate records of slices 510 in CCD table 530. Interaction insights system 100 may achieve data projection by retrieving relevant content and other metadata, as shown in FIG. 5, to generate canonical corpus of documents (CCD) table 530.

CCD table 530 includes the content of documents 132 along with various other metadata describing the content in fields 532-534. Metadata describing content may include data source type stored in document type field 532, a portion of a document stored in document slice field 533. Document type field 532 may include document types 520 indicating the type of service used by a user to interact with a service directly or through a service provider. For example, the type of service may be a chat message with a bot or a phone conversation with a service provider. In some embodiments, document type field 532 may also describe data source of data sources 160 (as shown in FIG. 1) from where content for a document slice is retrieved. Document slice field 533 may include what portion of a document is retrieved to store in CCD table 530. The retrieved portion may represent the person (e.g., user, service provider) whose portion of interaction was extracted or a section of interaction (e.g., description of a problem).

CCD table 530 may also include a unique identifier field 531 and the content field 535 with content from documents 132 that uniquely represent document slice. In some embodiments, CCD table 530 may include additional fields such as a document identifier identifying a document in documents 132, from which the value of content field 535 for a record in CCD table 530 was extracted by interaction insights system 100 using document projector 213. Document projector 213 may work with parser 122 to extract input data 161 and transform it to form documents 132 before analyzing itself to project documents 132 to generate CCD table 530. Document projector 213, upon completing data projection by extracting portions of data as documents slices and generating CCD table 530, stores CCD table 530 in corpus database 130. Document projector 213 may auto-extract document slices and generate records in CCD table 530 at regular intervals of time. In some embodiments, data projector 213 may be configured for trigger events to extract data from data sources 160 to store in CCD table 530. For example, a user may use configuration file 171 to configure document projector 213.

FIG. 6 is a diagram showing intent and action taxonomy determined using interaction insights system of FIG. 1, according to some embodiments of the present disclosure. As illustrated in FIG. 6, intents 135 may include various intentions of a user interacting with a service directly or through a service provider, and actions 136 are possible output provided by service providers as a response to interactions initiated by a user.

Interaction insights system 100 may use relations among various intents and actions and relationships between intents and actions to determine both the appropriate actions to respond to user interactions and insights of events, including user interaction intent and service provider action. Level (e.g., level 1) of intent (e.g., intent 1) and an action (e.g., action 201) used in insight generation may be based on user preferences. For example, a service provider may want specific insights into various possible interactions of users with their services that are listed in a configuration file. Each level in intents 135 and actions 136 may represent additional granularity of information used for the generation of insights and responses to user interaction using previously identified insights of user interactions. For example, in a healthcare context where a member of a healthcare network interacts with a healthcare provider about healthcare benefits provided by their employer may result in interaction having associated with various labels of different levels, such as intent 1 at level 1 may be “diabetes treatment,” action 101 at level 1 may be a “service recommended by a healthcare provider,” action 201 at level 2 may be a “specific diabetes management service,” action 301 at level 3 may be “Livongo treatment.”

In some embodiments, a hierarchical relationship among intents 135 and actions 136 may be configured by a user of interaction insights system 100. Interaction insights system 100 may include a default set of intents and actions and their relationships that can be overridden using a configuration file (e.g., configuration file 171 of FIG. 1). Configuration file 171 may also include paths mapping relation between intents 135 and actions 136 that helps define various events (e.g., encounters 134) and determine insights. Insights may include evaluation of paths between intents 135 and actions 136 and may include a user's satisfaction with a selected path as chosen by a service or a service provider, time taken by a user to follow the path, and use of the response provided in action (e.g., action 201). In some embodiments, insights may include evaluating steps represented by various intents and actions resulting in the selection of an action.

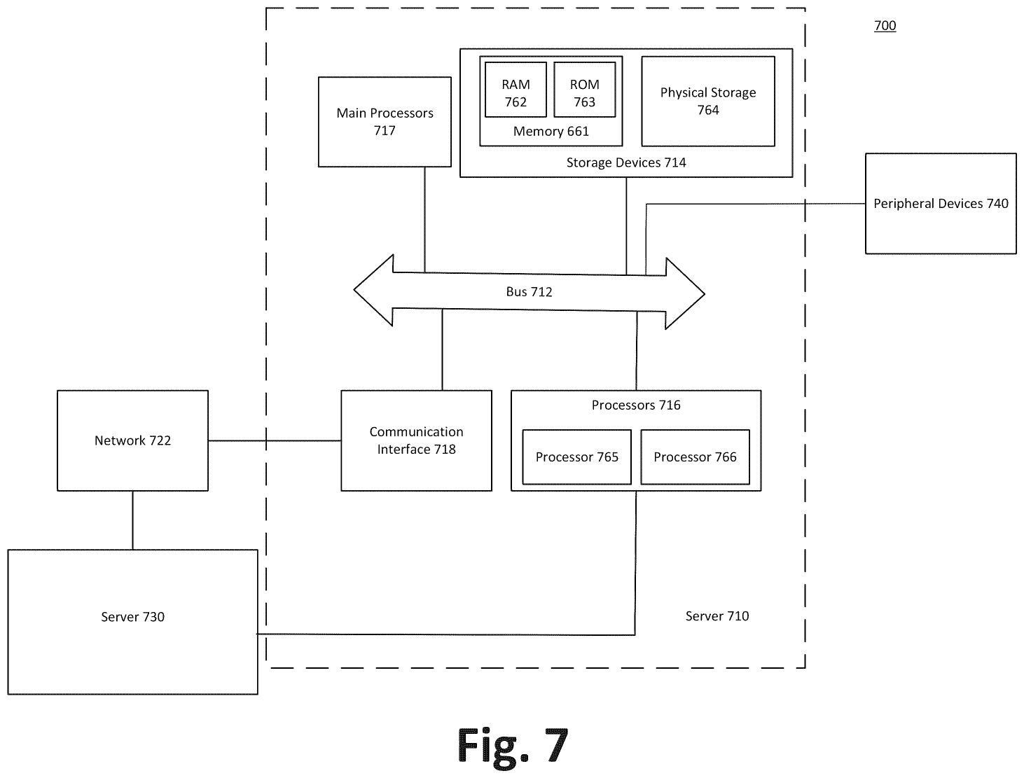

FIG. 7 illustrates a schematic diagram of an exemplary server of a distributed system, according to some embodiments of the present disclosure. According to FIG. 7, server 710 of distributed computing system 700 comprises a bus 712 or other communication mechanisms for communicating information, one or more processors 716 communicatively coupled with bus 712 for processing information, and one or more main processors 717 communicatively coupled with bus 712 for processing information. Processors 716 can be, for example, one or more microprocessors. In some embodiments, one or more processors 716 comprises processor 765 and processor 766, and processor 765 and processor 766 are connected via an inter-chip interconnect of an interconnect topology. Main processors 717 can be, for example, central processing units (“CPUs”).

Server 710 can transmit data to or communicate with another server 730 through a network 722. Network 722 can be a local network, an internet service provider, Internet, or any combination thereof. Communication interface 718 of server 710 is connected to network 722, which can enable communication with server 730. In addition, server 710 can be coupled via bus 712 to peripheral devices 740, which comprises displays (e.g., cathode ray tube (CRT), liquid crystal display (LCD), touch screen, etc.) and input devices (e.g., keyboard, mouse, soft keypad, etc.).

Server 710 can be implemented using customized hard-wired logic, one or more ASICs or FPGAs, firmware, or program logic that in combination with the server causes server 710 to be a special-purpose machine.

Server 710 further comprises storage devices 714, which may include memory 761 and physical storage 764 (e.g., hard drive, solid-state drive, etc.). Memory 761 may include random access memory (RAM) 762 and read-only memory (ROM) 763. Storage devices 714 can be communicatively coupled with processors 716 and main processors 717 via bus 712. Storage devices 714 may include a main memory, which can be used for storing temporary variables or other intermediate information during execution of instructions to be executed by processors 716 and main processors 717. Such instructions, after being stored in non-transitory storage media accessible to processors 716 and main processors 717, render server 710 into a special-purpose machine that is customized to perform operations specified in the instructions. The term “non-transitory media” as used herein refers to any non-transitory media storing data or instructions that cause a machine to operate in a specific fashion. Such non-transitory media can comprise non-volatile media or volatile media. Non-transitory media include, for example, optical or magnetic disks, dynamic memory, a floppy disk, a flexible disk, hard disk, solid] state drive, magnetic tape, or any other magnetic data storage medium, a CD-ROM, any other optical data storage medium, any physical medium with patterns of holes, a RAM, a PROM, and an EPROM, a FLASH-EPROM, NVRAM, flash memory, register, cache, any other memory chip or cartridge, and networked versions of the same.

Various forms of media can be involved in carrying one or more sequences of one or more instructions to processors 716 or main processors 717 for execution. For example, the instructions can initially be carried out on a magnetic disk or solid-state drive of a remote computer. The remote computer can load the instructions into its dynamic memory and send the instructions over a telephone line using a modem. A modem local to server 710 can receive the data on the telephone line and use an infra-red transmitter to convert the data to an infra-red signal. An infra-red detector can receive the data carried in the infra-red signal, and appropriate circuitry can place the data on bus 712. Bus 712 carries the data to the main memory within storage devices 714, from which processors 716 or main processors 717 retrieves and executes the instructions.

Interaction insights system 100 (as shown in FIG. 1) or one or more of its components may reside on either server 710 or 730 and may be executed by processors 716 or 717. In some embodiments, the components of interaction insights system 100, labeling module 110, and data processing module 120 may be spread across multiple servers 710 and 730. For example, labeling module 110 components 111-112 may be executed on multiple servers.

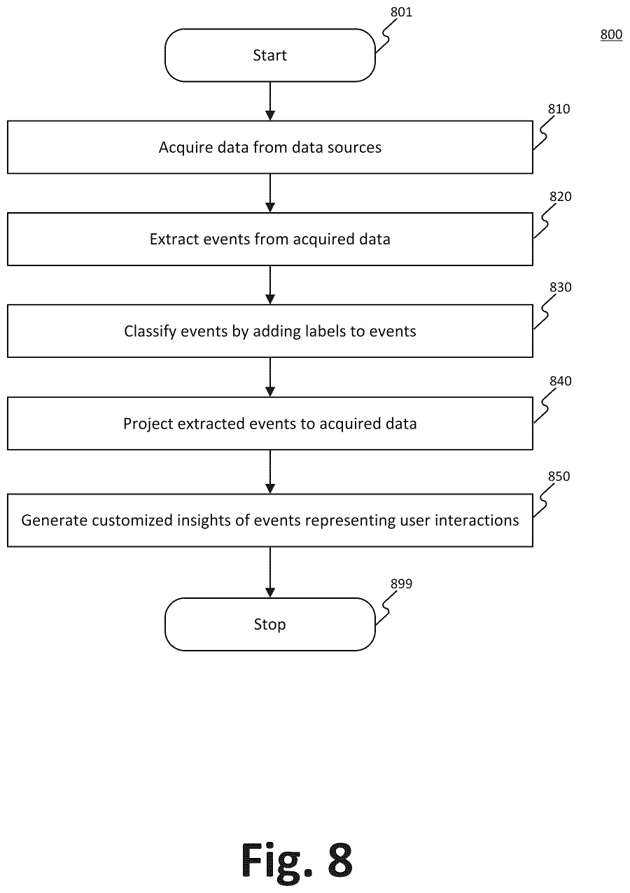

FIG. 8 is a flowchart showing an exemplary method for generating insights using labeled interaction content, according to some embodiments of the present disclosure. The steps of method 800 may be performed by, for example, interaction insights system 100 of FIG. 1 executing on or otherwise using the features of distributed computing system 700 of FIG. 7 for purposes of illustration. It is appreciated that the illustrated method 800 can be altered to modify the order of steps and to include additional steps.

In step 810, interaction insights system 100 may acquire data (e.g., input data 161 of FIG. 1) by retrieving data from data sources (e.g., data sources 160 of FIG. 1) through API calls to different services interacted by a user directly or through a service provider. In some embodiments, interaction insights system 810 may acquire previously retrieved data stored in a database (e.g., corpus database 130 of FIG. 1). Interaction insights system 100 may acquire data based on configuration (e.g., configuration file 171) provided by a user using user device 170. Configuration may include data sources and types of data to retrieve from various data sources. The type of data and data sources may depend on the insights requested by a user of interaction insights system 100. Interaction insights system may store acquired input data 161 as documents 132 in corpus database 130. In some embodiments, interaction insights system 100 may use parser 122 to parse input data 161 to normalize and/or make data uniform and store it as documents 132 in corpus database 130.

In some embodiments, interaction insights system 100 may retrieve interaction data in real-time when a user communicates with a service provider through email, chat message, or phone call.

In step 820, interaction insights system 100 may extract events from input data 161 by associating labels defining the contents of acquired input data 161. Interaction insights system 100 may employ annotator 111 and tagger 112 to associate labels with input data 161. Annotator 111 may provide annotations of input data 161 based on a configuration file (e.g., configuration file 171 of FIG. 1). Annotations may be provided using off-the-shelf tools such as MLFlow Run to ingest data based on configuration file 171 to generate annotation tasks 141 (as shown in FIG. 1). Interaction insights system 100 may use a web application such as doccano to list various possible annotations and use them as labels and apply them to the ingested data.

Interaction insights system 100 may use tagger 112 to determine additional labels identifying events and, in turn, insights of interaction content in input data 161. Interaction insights system 100 may determine tags to associate with data using machine learning models based on annotations associated with data using annotator 111. Tags associated with data may indicate events in input data 161 using additional details of an interaction between users with services directly and through service providers. In some embodiments, tags associated with input data 161 provide additional details, including the intentions of a user actions of a service provider. Interaction insights system 100 may determine events from additional details of intentions (e.g., intents 135 of FIG. 1) and actions (e.g., actions 136 of FIG. 1) by mapping determined intentions and actions in input data 161. Interaction insights system 100 may use a multi-label multi-class classification model to determine mappings between insights and actions.

In some embodiments, interaction insights system 100 may need to determine a hierarchy of tags indicating intentions and actions to identify the intentions and action tags at the right level to identify events. Interaction insights system 100 may select tag level based on the requested insights and determine the tags representing insights and actions at the required level using a machine learning (ML) model. Interaction insights system 100 may train a machine learning model of ML models 142 using the mappings between intentions and actions.

Interaction insights system 100 may use a trained ML model to determine the intent of a real-time communication between a user and a service provider and determine recommended actions based on the determined intent of the communication. Interaction insights system 100 may use a multi-label classifier model to determine action recommendations. In some embodiments, an interaction insights system may generate response messages to a user interaction based on determined recommendation actions and present them in a consumable format. The responses may include a chat response, a marketing email, or a link to a service search engine with pre-selected filters and keywords. In some embodiments, a response may also include graphs showing insights of intentions (e.g., intents 135 of FIG. 1).

In step 830, interaction insights system 100 may classify events by adding labels to events. Interaction insights system 100 may use a classifier ML model to classify events. Interaction insights system 100 may classify the input data 161 from step 810 by grouping labels determined in step 820 to a core topic that indicates the communication intent of a user with a service directly or through a service provider.

In step 840, interaction insights system 100 may project extracted events from step 830 to input data 161 from step 810 by generating slices of input data 161 as shown in FIG. 5 and projecting tags of input data 161 representing events to slices of input data 161. Interaction insights system 100 may generate a table to include slices of input data 161 as records and include additional information as fields of one or more records.

In some embodiments, interaction insights system 100 may take free text as input data 161 and output structured relational tables (e.g., Canonical corpus of documents (CCD) table 530 of FIG. 5) of various events. Relational tables may represent portions of free text representing communication between a set of individuals along with additional details (e.g., relational table fields 531, 532, 534, and 535 of FIG. 5). For example, in a healthcare context, a communication may include an interaction between a member of a healthcare network asking a healthcare network provider about maternity benefits and a portion of communication presented in relational tables (e.g., CCD table 530 of FIG. 5) may include questions from a member, responses by a healthcare provider, or a portion of an interaction between a member and healthcare provider discussing a specific maternity benefit.

In step 850, interaction insights system 100 may generate customized insights of events from step 830 representing user interactions using ML models selected from ML models 142 using a configuration file (e.g., configuration file 171 of FIG. 1). Insights may be customizable based on parameters in configuration file 171, Insights may include time taken and satisfaction of actions provided as a result of interaction initiated by a user. Time taken may be measured by if a user continues interaction related to the event after providing actions requested by a user and satisfaction based on whether a user utilized the proposed actions. Insights may also identify paths to action, thus helping better understand user intentions (e.g., intents 135 of FIG. 1) to associate with actions (e.g., actions 136 of FIG. 1) selected and utilized by a user.

In some embodiments, insights may be obtained by connecting data from various data sources (e.g., data sources 160 of FIG. 1). Interaction insights system 100 may connect various data sources using foreign keys in relational tables generated with projected events in step 840. In some embodiments, interaction insights system 100 may allow the connection configuration between various data sources and relational tables. A user of interaction insights system 100 may configure the connection between data sources 160 using configuration file 171 to specify the joins and aggregations to perform on relational tables (e.g., CCD table 530) to produce insight. Interaction insights system 100, upon completion of step 850, completes (step 899) executing method 800 on distributed computing system 700.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct one or more hardware processors of a computer, other programmable data processing apparatus, or other devices to function in a particular manner, such that the instructions stored in the computer readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer readable medium(s) may be utilized. The computer readable medium may be a non-transitory computer readable storage medium. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

1. A non-transitory computer readable medium including instructions that are executable by one or more processors to cause a system to perform a method for customized insights, the method comprising:
receive a request for one or more customized insights;
acquiring data through API calls from one or more sources selected based on the requested one or more customized insights, wherein the one or more sources format and organize data differently;
extracting with a transformer, from the acquired data, events that each represent an interaction between a user and a service;
normalizing, with the transformer, the acquired data to a uniform format;
connecting, with the transformer, data, wherein the transformer stores the connected data in a database;
classifying, using a classifier model, the extracted events by adding one or more labels to each of the extracted events, wherein the classifier model is trained on the connected data stored in the database;
projecting the extracted events to the acquired data to generate a relational table, wherein records of the relational table include the extracted events and one or more slices of the acquired data;
connecting data from the one or more sources in the relational table by determining, based on a configuration file, one or more joins or aggregations to perform on the data; and
generating the one or more customized insights from the relational table of the extracted events representing user interactions based on the one or more labels associated with the each of the extracted events.

2. The non-transitory computer readable medium of claim 1, wherein extracting, from the acquired data, events further comprises:
receiving, for the acquired data, one or more annotations that are defined using a configuration file and that indicate an event of the events in the data; and
determining one or more tags to associate with the acquired data using machine learning models based on the one or more annotations, wherein the one or more tags indicate one or more intentions of the user and one or more actions of the service provider, wherein the one or more tags indicate the extracted events in the data.

3. The non-transitory computer readable medium of claim 2, wherein the one or more tags indicate the extracted events using one or more mappings between the one or more intentions and the one or more actions.

4. The non-transitory computer readable medium of claim 3, wherein one or more mappings between the one or more intentions and the one or more actions is determined using a multi-label multi-class classification model.

5. The non-transitory computer readable medium of claim 3, wherein a machine learning model of the machine learning models is trained using the one or more mappings between the one or more intentions and the one or more actions.

6. The non-transitory computer readable medium of claim 5, wherein the operations further comprise:
receiving a communication from a user;
determining intent of the communication using the trained machine learning model;
determining one or more recommendation actions based on the determined intent of the communication, wherein the one or more recommendations are generated by a multi-label classifier;
generating one or more responses associated with the one or more recommendation actions; and
presenting the one or more response communications in a consumable format.

7. The non-transitory computer readable medium of claim 6, wherein the received communication is at least one of: an email, a chat message, or a phone call.

8. The non-transitory computer readable medium of claim 2, wherein determining one or more tags to associate with the data using machine learning models includes generating a hierarchy of the one or more tags.

9. The non-transitory computer readable medium of claim 2, wherein projecting the extracted events to the acquired data to generate a relational table further comprises:
generating the one or more slices of the acquired data; and
projecting the one or more slices of the acquired data to the one or more tags representing the extracted events.

10. The non-transitory computer readable medium of claim 9, wherein projecting the one or more slices of the acquired data to the one or more tags representing the extracted events-further comprises:
generating the relational table to include the one or more slices of the acquired data as one or more records;
including the one or more slices of the acquired data as fields of the one or more records; and
including additional information as additional fields of the one or more records.

11. The non-transitory computer readable medium of claim 1, wherein classifying, using a classifier model, the acquired data by adding one or more labels to each of the acquired data further comprises:
grouping the one or more labels to a core topic, wherein the core topic indicates the communication intent of the user.

12. The non-transitory computer readable medium of claim 1, wherein generating the one or more customized insights from the relational table of the extracted events representing user interactions is based on the machine learning models selected from a machine learning models repository using a configuration file.

13. A method performed by a system for customized insights utilizing an interaction insight system, the method comprising:
receiving a request for one or more customized insights;
acquiring data through API calls from one or more sources selected based on the requested one or more customized insights, wherein the one or more sources format and organize data differently;
extracting with a transformer, from the acquired data, events that each represent an interaction between a user and a service;
normalizing, with the transformer, the acquired data to a uniform format;
connecting, with the transformer, data, wherein the transformer stores the connected data in a database;
classifying, using a classifier model, the extracted events by adding one or more labels to each of the extracted events, wherein the classifier model is trained on the connected data stored in the database;
projecting the extracted events to the acquired data to generate a relational table, wherein records of the relational table include the extracted events and one or more slides of the acquired data;
connecting data from the one or more sources in the relational table by determining, based on a configuration file, one or more joins or aggregations to perform on the data; and
generating the one or more customized insights from the relational table of the extracted events representing user interactions based on the one or more labels associated with the each of the extracted events.

14. The method of claim 13, wherein extracting, from the acquired data, events further comprises:
receiving, for the acquired data, one or more annotations that are defined using a configuration file and that indicate an event of the events in the data; and
determining one or more tags to associate with the acquired data using machine learning models based on the one or more annotations, wherein the one or more tags indicate one or more intentions of a user and one or more actions of a service provider, wherein the one or more tags indicate the extracted events in the data.

15. The method of claim 14, wherein the one or more tags indicate the extracted events using one or more mappings between the one or more intentions and the one or more actions.

16. The method of claim 15, wherein a machine learning model of the machine learning models is trained using the one or more mappings between the one or more intentions and the one or more actions.

17. The method of claim 16, wherein the operations further comprise:
receiving a communication from the user;
determining intent of the communication using the trained machine learning model;
determining one or more recommendation actions based on the determined intent of the communication, wherein the one or more recommendations are generated by a multi-label classifier;
generating one or more responses associated with the one or more recommendation actions; and
presenting the one or more response communications in a consumable format.

18. The method of claim 14, wherein projecting the extracted events to the acquired data to generate a relational table further comprises:
generating the one or more slices of the acquired data; and
projecting the one or more slices of the acquired data to the one or more tags representing the extracted events.

19. The method of claim 18, wherein projecting the one or more slices of the acquired data to the one or more tags representing the extracted data further comprises:
generating the relational table to include the one or more slices of the acquired data as one or more records;
including the one or more slices of the acquired data as fields of the one or more records; and
including additional information as additional fields of the one or more records.

20. An interaction insight system comprising:
one or more memory devices storing processor-executable instructions; and
one or more processors configured to execute instructions to cause the interaction insights system to perform:
receiving a request for one or more customized insights
acquiring data through API calls from one or more sources selected based on the requested one or more customized insights, wherein the one or more sources format and organize data differently;
extracting with a transformer, from the acquired data, events that each represent an interaction between a user and a service;
normalizing, with the transformer, the acquired data to a uniform format;
connecting, with the transformer, data, wherein the transformer stores the connected data in a database;
classifying, using a classifier model, the extracted events by adding one or more labels to each of the extracted events, wherein the classifier model is trained on the connected data stored in the database;
projecting the extracted events to the acquired data to generate a relational table, wherein records of the relational table include the extracted events and one or more slices of the acquired data;
connecting data from the one or more sources in the relational table by determining, based on a configuration file, one or more joins or aggregations to perform on the data; and
generating the one or more customized insights from the relational table of the extracted events representing user interactions based on the one or more labels associated with the each of the extracted events.
